(19) United States
(12) Patent Application Publication
(10) Pub. No.: US 2009/0099761 A1
(43) Pub. Date: Apr. 16, 2009

(54) WIRELESS, BATTERY-POWERED, PHOTOVOLTAICALLY CHARGED AND MONITORED RUNWAY-BASED AIRCRAFT IDENTIFICATION SYSTEM AND METHOD

(75) Inventors: Lavelle Davis, Jacksonville, FL (US); Mark Nichols, Jacksonville, FL (US)

Correspondence Address: MARK YOUNG, P.A., 12086 FORT CAROLINE ROAD, UNIT 202, JACKSONVILLE, FL, 32225, US

(73) Assignee: GENPOWER, INC., JACKSONVILLE, FL (US)

(21) Appl. No.: 11/870,421

(22) Filed: Oct. 11, 2007

(51) Int. Cl. G08G 5/00

(52) U.S. Cl. 701/120

(57) ABSTRACT

A battery-powered runway-based aircraft identification system includes a frangibly mounted image capture and communication subsystem adjacent to an airport runway. A power supply subsystem adjacent to the frangibly mounted image capture and communication subsystem is operably coupled to the frangibly mounted image capture and communication subsystem and configured to controllably supply electrical power to the frangibly mounted image capture and communication subsystem. The power supply subsystem includes at least one frangibly mounted solar panel operably coupled to a deep cycle battery and charge controller. A remote base station configured for wireless communication with the frangibly mounted image capture and communication subsystem monitors charge status of the battery and determines an aircraft identification from the frangibly mounted image capture and communication subsystem.

### FIELD OF THE INVENTION

This invention generally relates to a system for tracking aircraft landing and/or taking off at an airport, and more particularly, to a wireless, battery-powered, photovoltaically charged and monitored, runway-based system and method configured to capture images of identification characters on arriving and departing aircraft, digitize the imaged identification information, wirelessly communicate the images and/or digital information to a remote location, monitor the charge status of the system and communicate alert signals to the remote location if a charge malfunction is detected.

### BACKGROUND

Accurate information on aircraft activity at airports is of significant concern to aircraft and airport owners and operators, governmental agencies such as the Federal Aviation Administration (FAA) in the United States, as well as to those responsible for planning, developing, and administering airport facilities. Such tracking is necessary for traffic control, security, facilities management and assessing fees.

Aircraft may be identified for tracking by an aircraft registration, a unique alphanumeric string that identifies a civilian aircraft. Because airplanes typically display their registration numbers on the aft fuselage just forward of the tail, and in earlier times more often on the tail itself, the registration is often referred to as the “tail number”. In the United States, the registration number is also referred to as an “N-number”, as it starts with the letter N.

The International Civil Aviation Organization maintains the standards for aircraft registration. Article 20 of the Chicago Convention on International Civil Aviation requires that all signatory countries register aircraft over a certain weight with a national aviation authority. Upon registration, the aircraft receives its unique “registration” which must be displayed prominently on the aircraft. Annex 7 to the Convention on International Civil Aviation describes the definitions, location, and measurement of nationality and registration marks. The aircraft registration is made up of a prefix selected from the country's call sign prefix allocated by the International Telecommunication Union (ITU) (making the registration a quick way of determining the country of origin) and the registration suffix. Depending on the country of registration, this suffix is a numeric or alphanumeric code and consists of one to five digits or characters respectively.

Due to the large numbers of aircraft registered in the United States an alpha-numeric registration suffix system is used. N-numbers may only consist of 1 to 5 characters and must start with a number other than zero and cannot end in more than two letters. In addition, N-numbers may not contain the letters I or O, due to their close similarity with the numbers 1 and 0. Thus, each alphabetic character in the suffix can have one of 24 discrete values, while each numeric digit can be one of 10, except the first, which can take on only nine values. This yields a total of 915,399 possible registration numbers in the namespace, though certain combinations are reserved either for government use or for other special purposes.

Unfortunately, the process of tracking landings and take-offs has varied widely from airport to airport. Current procedures include mere visual observation, barcode scanning and radio frequency identification. Each method has its strengths and weaknesses in terms of accuracy, cost, ease of use, and suitability to a particular airport. By way of example, large commercial aircraft are equipped with an expensive and complex transponder, that when interrogated by expensive and complex interrogation equipment, returns an aircraft identification. This technology is not universally required by regulatory authorities, such as on smaller aircraft and general aviation aircraft. Additionally, the transponder can be inadvertently turned off on larger commercial aircraft.

As another example, U.S. Pat. No. 5,375,058 to Bass describes a system that utilizes multiple infrared scanners in close proximity to runways and taxiways. It can track aircraft and vehicles using bar-coding identification. Data from these scanners and detectors is processed and displayed on a digital map of the airport. It utilizes aircraft tail numbers as an index but relies on a “master host memory” which contains flight numbers, aircraft characteristics, and the like.

Yet another example, is US Application Publication No. 2002/0082769 by Church, et al., which describes a camera-based system that is powered from a runway lighting system and uses a near infrared illuminator for night-time imaging, a video camera, a mechanism for detecting when the aircraft moves, a processor for identifying a tail number from a captured image, and a storage medium that stores the tail number of the aircraft. Unfortunately, however, many airports are averse to tapping into runway lighting systems for electrical power. Concomitantly, it can be prohibitively expensive for small airports to run utility power and digital communication wiring to the end of a runway.

What is needed is a wireless, battery-powered, automatically recharged, monitored, runway-based system and method configured to capture images of identification characters on arriving and departing aircraft, digitize the imaged identification information, wirelessly communicate the images and/or digital information to a remote location, monitor the charge status of the system and communicate alert signals to a remote location if a charge malfunction is detected. The invention is directed to overcoming one or more of the problems and solving one or more of the needs as set forth above.

### SUMMARY OF THE INVENTION

To solve one or more of the problems set forth above, in an exemplary implementation of the invention, a battery-powered runway-based aircraft identification system is provided. The system includes a frangibly mounted image capture and communication subsystem adjacent to an airport runway. A power supply subsystem adjacent to the frangibly mounted image capture and communication subsystem is operably coupled to the frangibly mounted image capture and communication subsystem and configured to controllably supply electrical power to the frangibly mounted image capture and communication subsystem. The power supply subsystem includes at least one frangibly mounted solar panel operably coupled to a deep cycle battery and charge controller. A remote base station configured for wireless communication with the frangibly mounted image capture and communication subsystem monitors charge status of the battery and determines an aircraft identification from the frangibly mounted image capture and communication subsystem.

An exemplary frangibly mounted image capture and communication subsystem includes a control unit including a memory and transceiver. The exemplary frangibly mounted image capture and communication subsystem also includes a digital video camera configured with a field of view comprising a portion of the airport runway through which aircraft travel. The digital video camera is configured to capture digital video of aircraft on the runway. A sensor is provided to detect the presence of aircraft in the field of view. The sensor is operably coupled to the control unit, and configured to generate a detection signal and communicate the detection signal to the control unit. The control unit is configured to cause the digital video camera to capture video of the field of view when a detection signal has been received from the sensor by the control unit.

The exemplary control unit is also configured to receive video image data from the digital video camera in memory of the control unit, and is further configured to wirelessly communicate the video image data to the remote base station. The remote base station is configured to receive the video image data and determine an aircraft identification from the video image data by optical character recognition.

The power supply subsystem includes a charge controller operably coupled to the solar panel and to the deep cycle battery. The charge controller is configured to prevent overcharging of the deep cycle battery, overdischarging of the deep cycle battery, and reverse current drain from the deep cycle battery to the solar panel in dark conditions. The charge controller also includes circuitry that determines the voltage of the deep cycle battery and regulates the current supplied from the frangibly mounted solar panel to the deep cycle battery using Pulse Width Modulation or Maximum Power Point Tracking. The deep cycle battery is an absorbed glass mat battery. Optionally, an inverter is operably coupled to the deep cycle battery and configured to convert output of the deep cycle battery to alternating current, preferably having a sine wave, quasi-sine wave or modified sine wave waveform. A frangible mount supports the frangibly mounted solar panel. The charge controller, battery and inverter may be positioned beneath the frangibly mounted solar panel.

The frangibly mounted image capture and communication subsystem determines if output voltage of the deep cycle battery communicated from the charge controller is less than a determined voltage. A fault signal is communicated to the remote base station if the determined output voltage of the deep cycle battery communicated from the charge controller is less than a determined voltage.

A method for battery-powered runway-based aircraft identification includes steps of producing electrical energy from light energy using a solar panel, determining a charge status of a battery using a charge controller, and if the battery is not fully charged, charging the battery using the electrical energy from the solar panel, communicating the charge status to a control unit, analyzing the charge status using the control unit to determine if there is a fault, and, in the event of a fault, producing a fault signal and wirelessly transmitting the fault signal to a remote base station, and receiving the fault signal at the base station and generating an alarm. The method may also include steps of monitoring a field of view of a runway for aircraft, and, if an aircraft is detected, capturing video of the aircraft including identification information displayed on the aircraft, and if there is insufficient natural ambient light for a good quality video then activating an illuminator while the video is captured, and transmitting the video from the camera to the control unit and then wirelessly to the remote base station. Furthermore, the method may include receiving the communicated video at the base station, and determining an aircraft identification from the video, and correlate the aircraft identification with a record of a database.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a high level schematic of an exemplary wireless, battery-powered, photovoltaically charged and monitored, runway-based system and method configured to capture images of identification characters on arriving and departing aircraft, digitize the imaged identification information, wirelessly communicate the images and/or digital information to a remote location, monitor the charge status of the system and communicate alert signals to the remote location if a charge malfunction is detected according to principles of the invention; and

FIG. 2 shows a high level schematic of an exemplary wireless, battery-powered, controller unit configured to control operation of a camera and light to capture images of identification characters on arriving and departing aircraft, digitize the imaged identification information, wirelessly communicate the images and/or digital information to a remote location, monitor the charging status of the system and communicate alert signals to the remote location if a charge malfunction is detected according to principles of the invention; and

FIG. 3 shows a high level schematic of an exemplary power supply system comprising a solar panel, charge controller, battery and optional inverter according to principles of the invention; and

FIG. 4 shows a high level schematic of an exemplary runway with an exemplary wireless, battery-powered, photovoltaically charged and monitored, runway-based system and method configured to capture images of identification characters on arriving and departing aircraft, digitize the imaged identification information, wirelessly communicate the images and/or digital information to a remote location, monitor the charge status of the system and communicate alert signals to the remote location if a charge malfunction is detected according to principles of the invention; and

FIG. 5 shows a high level flowchart of an exemplary methodology for wireless, battery-powered, photovoltaically charged and monitored, runway-based capturing of images of identification characters on arriving and departing aircraft, communicating the images and/or digital information to a remote location, monitoring the charge status of the system and communicate alert signals to the remote location if a charge malfunction is detected according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the locations, shapes, relative sizes, ornamental aspects or proportions shown in the figures.

### DETAILED DESCRIPTION

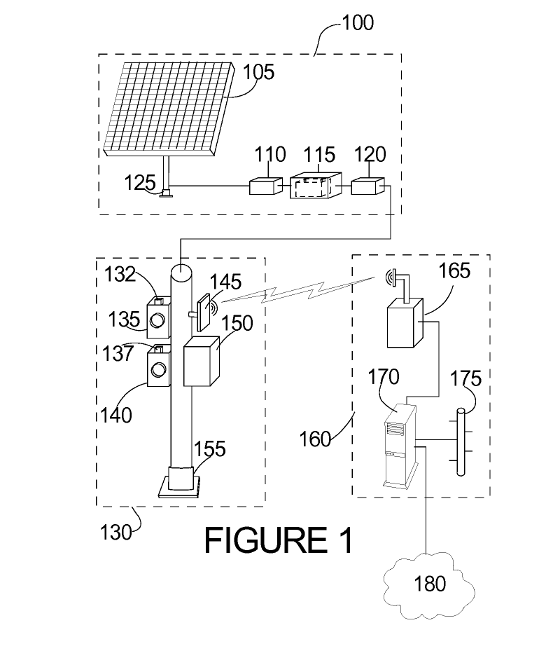

Referring to the Figures, in which like parts are indicated with the same reference numerals, various views of an exemplary wireless, battery-powered, photovoltaically charged and monitored, runway-based system and method configured to capture images of identification characters on arriving and departing aircraft, digitize the imaged identification information, wirelessly communicate the images and/or digital information to a remote location, monitor the charge status of the system and communicate alert signals to the remote location if a charge malfunction is detected according to principles of the invention are shown. Referring first to FIG. 1, the exemplary system includes three subsystems (also referred to herein as systems), namely a power supply subsystem 100, an image capture and communication subsystem 130, and a remote base station 160.

The system is designed to operate 24 hours a day, in all weather and lighting conditions. As the image capture and communication subsystem 130 employs a power supply subsystem 100 featuring batteries recharged by solar panels, the image capture and communication subsystem 130 does not require any utility power or a connection to the runway lighting system, and may be located anywhere on a runway, even areas that do not have utility power service. The system captures, processes and wirelessly transmits aircraft identification data from all aircraft passing a part of the runway in the system's field of view. The system utilizes conventional aircraft identification markings and does not require a bar code, transponder or special format markings to be used on the aircraft for identification. Rather, conventional alphanumeric characters, as captured by a video camera, are decoded using optical character recognition. The identification data may be correlated with owner and operator information in a central database to provide for landing and parking fee invoicing and other reports that might be required by the airport management authority.

The power supply subsystem 100 includes a photovoltaic panel (i.e., solar panel) 105 comprising solar cells or solar photovoltaic arrays to convert light, such as sunlight, into electrical power. The solar cells may be packaged in photovoltaic modules, electrically connected in multiples as solar photovoltaic arrays, to convert sufficient energy from sunlight into electricity to meet operating requirements. As the solar cells require protection from the environment, they are packaged behind a protective transparent (e.g., glass) sheet.

The solar panel 105 preferably has an orientation and angle of inclination to take advantage of the sun's energy. In general, if the solar panel 105 is stationary (i.e., non-tracking), in the Northern Hemisphere it should point toward true south (i.e., the orientation) and should be inclined at an angle equal to the area's latitude to absorb the maximum amount of energy year-round. A different orientation and/or inclination may be used to maximize energy production in the morning or afternoon, and/or the summer or winter. The solar panel 105 should not be shaded by nearby trees, buildings or other objects, no matter the time of day or the time of year.

The solar panel 105 produces direct current electricity from light, which is used to charge one or more batteries 115. If a plurality of batteries is used, they may be connected in series and/or in parallel. A parallel combination of batteries has the same voltage as a single battery, but can supply a higher current (the sum of the currents from all the batteries). A series combination has the same current rating as a single battery but its voltage is the sum of the voltages of all the batteries.

The solar panel 105 is preferably sized to recharge a battery 115 within a determined amount of time, during prevailing average daytime lighting conditions. For example, one or more solar panels may be provided to deliver enough current (amps) per hour in average daylight conditions to supply enough amp hours to fully recharge the one or more batteries within a few hours or so, while the power supply subsystem 100 supplies all necessary power to the image capture and communication subsystem 130. The time required will depend upon the specifications and conditions of the battery or batteries, the solar panel or solar panels, and the lighting conditions. The size and/or number of batteries are preferably more than sufficient to supply power to meet operating requirements of the image capture and communication subsystem 130 throughout dusk and nighttime, and overcast days.

Although various kinds of batteries may be employed, preferably a deep-cycle battery 115 is utilized. By way of example and not limitation, the deep-cycle battery 115 may be a sealed or vented lead-acid battery, a nickel-cadmium battery, or some other type of deep cycle battery now known or hereafter developed. In a particular preferred embodiment the battery is an absorbed glass mat, or AGM battery, with electrolyte (acid) contained in a fine fiber Boron-Silicate glass mat that prevents spillage, even if broken, and withstands shock and vibration. Advantageously, an AGM battery also resists freezing damage, recombines oxygen and hydrogen inside the battery while charging to prevent the loss of water through electrolysis, maintains low internal resistance which avoids heating of the battery even under heavy charge and discharge currents, offer low self-discharge of approximately 1% to 3% per month.

Another component of the power supply subsystem 100, a charge controller 110, electrically coupled between the solar panel 105 and the battery 115, manages the electrical current supplied from the solar panel 105 to the battery 115 to assure maximum useful life. The charge controller 110 does so by fully charging the battery 115 without permitting overcharge while preventing reverse current flow at night. Circuitry in the controller 110 reads the voltage of the battery 115 to determine the state of charge. Based upon the detected voltage, the controller 110 regulates the current supplied from the solar panel to the battery 115, preferably using either Pulse Width Modulation (PWM) or Maximum Power Point Tracking (MPPT). Illustratively, a PWM controller 110 maintains the battery 115 at its maximum state of charge and minimizes sulfation build-up by pulsing the voltage at a high frequency. A PWM controller 110 will first hold the voltage to a safe maximum for the battery 115 to reach full charge. Then it will drop the voltage lower to sustain a “finish” or “trickle” charge. An MPPT controller will adjust the voltage and current supplied from the solar panel 105 to the battery 115, to maximize the recharging current supplied to the battery 115. The controller also provides reverse current leakage protection by disconnecting the solar panel or using a blocking diode to prevent current loss into the solar modules at night. The controller also provides low-voltage load disconnect (LVD) to reduce damage to the battery 115 by avoiding deep discharge. When overdischarge is detected (e.g., when a 12 volt battery 115 drops below 11 volts), an LVD circuit will disconnect loads and reconnect the loads only when the battery 115 voltage has substantially recovered due to recharging. A typical LVD reset point is 13 volts. In addition, the controller provides overcurrent protection with fuses, circuit breakers. Because the battery 115 is used outdoors, the controller also provides temperature compensation, adjusting the charging voltage to the temperature. If the battery 115 temperature differs more than a determined threshold, such as 5° C., from a reference temperature, such as 20° C., the end-of-charge voltage may corrected by a correction factor, which has the effect of increasing the end-of-charge voltage as temperature decreases.

The solar panel 105, regardless of its size or sophistication, generates only direct current (DC). If the image capture and communication subsystem 130 requires only DC, an inverter 120 may be unnecessary. However, an inverter is required if the image capturing system requires an alternating current (AC) load. The inverter 120 converts DC output of the battery 115 to standard AC power similar to that supplied by utilities. In a preferred embodiment, the inverter, if required, is a solid state electronic device that uses pulse width modulation and a low pass filter at the inverter output to produce a sine wave, quasi-sine wave or modified sine wave output waveform.

The solar panel may be located in proximity to the image capture and communication subsystem 130, which is located adjacent to the runway. To comply with Federal Aviation Administration (FAA) guidelines, the solar panel 105 is preferably supported by a structure 125 that includes a frangible joint which functions as an easy breakaway of the solar panel 105 and upper end of the support structure 125 when, for example, an aircraft, maintenance vehicle, or other forces exert a predetermined pressure on the frangible section sufficient to cause breaking thereof. The frangible section may comprise a groove scored into the support structure, which groove is designed with a sufficient length, depth, and orientation in the support structure 125 to facilitate separation of the solar panel 105 and upper end of the support structure 125 at or near the surface of the ground. The frangible section can also comprise a compressed powderized metal coupler designed to separate under predetermined stress parameters utilized in accordance with the particular application. In any case, the function of the frangible connection is to facilitate a breakaway function under stressed conditions to protect the system and the aircraft that may impact the system from major damage.

The power supply subsystem 100 is electrically coupled to and adapted to provide electrical power to the image capture and communication subsystem 130. The image capture and communication subsystem 130 captures images of aircraft, particularly aircraft tail numbers, using a video camera 135, processes image data using a control unit 150, and wirelessly transmits the processed image data either directly to a remote base station 160 or indirectly through a remote repeater unit to a remote base station 160.

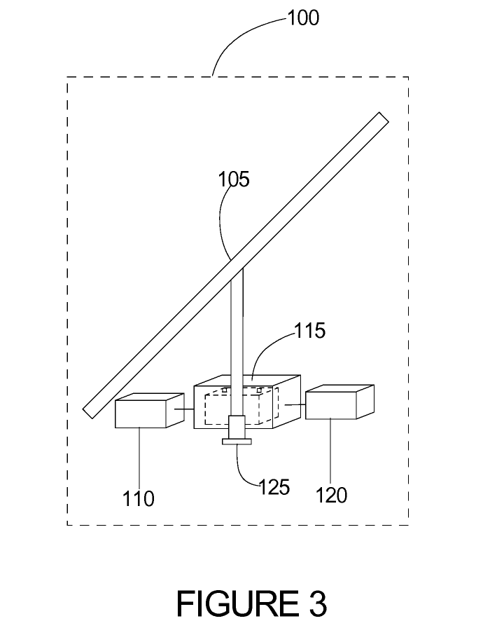

In a preferred embodiment, components of the power supply subsystem 100 are positioned beneath the solar panel 105, as shown in FIG. 3. Such an arrangement shields the covered components 110-120 from some environmental elements, thus reducing wear and tear while improving operating performance.

The power supply subsystem 100 is designed for continuous battery operation in all environmental conditions. The battery 115 is recharged during the day from the solar panel 105. All components of the image capture and communication subsystem 130 are powered 24 hours a day, 7 days a week by the power supply subsystem 100. The preferred power supply subsystem 100 provides 115 VAC power and/or 12VDC power to the image capture and communication subsystem 130.

Components of the power supply subsystem 100 and the image capture and communication subsystem 130 may be protected in environmentally sealed housings. The housings are adapted to accommodate full functionality of the housed component. Temperature sensors, heating elements, heat sinks, vents and cooling fans may be provided to help regulate the operating environment, depending upon the climate and operating requirements of the housed components.

The invention is not limited to any particular camera, so long as it is suitable for outdoor surveillance. However, in a preferred embodiment, a digital, weatherproof camera with night vision, infrared or near infrared imaging capability is preferred. An exemplary camera 135 is an industrial grade, weather proof, high sensitivity, high-resolution, black and white (or color), digital video camera. The exemplary camera 135 is sensitive to near infra-red as well as visible, ambient light, and is augmented with a compatible illuminator that controllably emits light invisible to the human eye, to ensure that images are detected and captured, even in total darkness. In an exemplary implementation, the camera will be fixedly aimed at a particular part of a runway. The camera 135 captures prominent aircraft markings displayed on the aircraft (i.e., tail numbers) which may be decoded using optical character recognition and used for surveillance, auditing and invoicing, without limitation to any security or safety application.

The camera 135 is operably coupled to the control unit 150. Image signals and/or image data from the camera are communicated to the control unit 150. Control signals from the control unit 150 are communicated to the camera 135. The control unit 150 and camera 135 are configured to control the start and end of recording for each aircraft imaged.

In an exemplary embodiment, the video camera 135 does not run continuously. Instead, the camera 135 captures video images only when an aircraft is present. Illustratively, as an aircraft is detected in the field of view of the camera, video recording may begin. Recording may continue for a determined period of time, a determined number of video frames, and/or until the aircraft is detected to have left the field of view.

One or more sensors 132 are provided to detect the presence of an aircraft and trigger video recording operations. Optical, infrared, inductive, thermal and/or acoustic sensors may be utilized to detect the presence of an aircraft within, near or approaching the field of view. Such sensors 132 may be coupled to or included with any of the components in the image capture and communication subsystem 130, and operably connected to the control unit 150.

Upon detecting the presence of an aircraft, the sensor 132 produces a signal, e.g., a detect signal, which is communicated to the control unit 150. Upon receiving a detect signal, the control unit generates a record signal and communicates it to the video camera 135. Upon receiving a record signal, the video camera 135 begins recording.

To facilitate nighttime image capturing, an illuminator 140 is provided. The illuminator 140 is operably coupled to the control unit 150 and adapted to be responsive in low light conditions. The illuminator 140 is preferably a long range solid-state infrared LED illuminator configured to transmit a beam that is substantially invisible to the human eye and focused to distinguish airplane tail numbers to a distance of approximately 200 feet, i.e., the wingspan of a Boeing 777. The illuminator may be equipped with a photosensor adapted to detect low light conditions and deactivate the illuminator when adequate ambient light is available. Light emitted from the illuminator 140 substantially improves the quality of captured images, without distracting pilots or passengers because the infrared light is invisible to the human eye.

The control unit 150 may activate the illuminator 140 to cause the illuminator 140 to illuminate the field of view while the video camera 135 records. In an exemplary embodiment, a photosensor 137 is coupled to the control unit 150 to detect the presence of adequate ambient lighting. In a preferred implementation, if the photosensor 137 does not detect adequate ambient lighting conditions, the control unit responds by activating the illuminator 140 when a record signal is received by the control unit 150. Upon receiving activation, the illuminator 140 emits visible or invisible (e.g., infrared, mid infrared or near infrared) light to illuminate the field of view while the camera 135 records.

The components of the image capture and communication subsystem 130 may be mounted on a vertical support 155, such as a post, located in proximity to the power supply subsystem 100, which is located adjacent to the runway. To comply with Federal Aviation Administration (FAA) guidelines, the vertical support 155 is preferably includes a frangible joint which functions as an easy breakaway of the supported components and upper end of the support structure 155 when, for example, an aircraft, maintenance vehicle, or other forces exert a predetermined pressure on the frangible section sufficient to cause breaking thereof. The frangible section may comprise a groove scored into the support structure, which groove is designed with a sufficient length, depth, and orientation in the support structure 155 to facilitate separation of the mounted components and upper end of the support structure 155 at or near the surface of the ground. The frangible section can also comprise a compressed powderized metal coupler designed to separate under predetermined stress parameters utilized in accordance with the particular application. In any case, the function of the frangible connection is to facilitate a breakaway function under stressed conditions to protect the system and the aircraft that may impact the system from major damage.

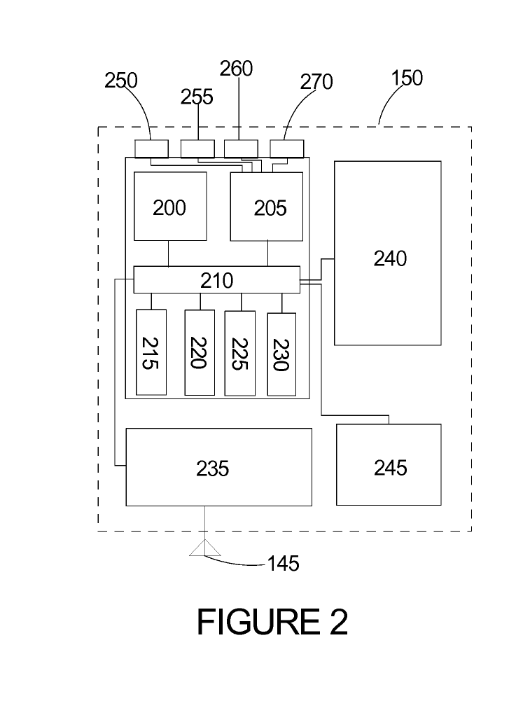

Referring now to FIG. 2, the control unit 150 receives both analog and digital data input, provides output power to support connected devices, and wirelessly transmits signals to a remote base station and/or repeater. The control unit 150 is configured with a microcontroller 200, an interface controller 205, a BIOS 215, memory 220, a thermal sensor 225, a timer 230 a radio transceiver or transmitter module 235, an optional video encoder 240 to support an analog video camera, a power supply 245, and a plurality of digital and analog input ports 250 to 270, and a bus 210 to operably couple the components. The plurality of digital and analog input ports 250 to 270 may include a power supply 250, a voltage monitoring input 260, a video input 260 and an illuminator output 270. Additional and different input and output ports may be provided without departing from the scope of the invention.

The radio module 235 and antenna 145 communicate signals wirelessly to a compatible remote base station 160 equipped to receive and process the signals. By way of example and not limitation, a long range (e.g., at least 1 mile) wireless system (e.g., WIMAX) that uses licensed or unlicensed spectrum to deliver point to point wireless communication outdoors may be utilized. Within these parameters, the invention is not limited to any particular wireless communication protocol or standard.

In a preferred embodiment captured video data is time stamped and wirelessly communicated to the remote base station 160, either directly from the image capture and communication subsystem 130, or indirectly through one or more repeater units disposed between the image capture and communication subsystem 130 and remote base station 160. In one embodiment, the image capture and communication subsystem 130 decodes aircraft identification information from the captured video by optical character recognition. In such an embodiment, to conserve bandwidth, the image capture and communication subsystem 130 may communicate only the decoded identification information to the remote base station 160.

In an alternative embodiment, the remote base station 160 decodes aircraft identification information from the captured video by optical character recognition. In such an embodiment, the image capture and communication subsystem 130 may communicate the captured video data to the remote base station 160. The image capture and communication subsystem 130 may encode or transcode the captured video into a determined format (e.g., an MPEG format), compress the encoded video and encrypted the compressed packet before wirelessly communicating it to the remote base station 160. Alternatively, the image capture and communication subsystem 130 may stream the captured and encoded video to a base unit 165 of the remote base station 160. Once the video data is received by the base unit 165, it is communicated to computer 170 which decodes aircraft identification information from the captured video by optical character recognition.

The image capture and communication subsystem 130 is configured to monitor the status of the power supply subsystem 100. In an exemplary configuration, the charge status (e.g., battery voltage and current) of the power supply subsystem 100, as may be determined by the recharge controller 110, is monitored continuously by the control unit 150 of the image capture and communication subsystem 130. Solar panel 105 output voltage and current may also be determined by the recharge controller 110 and monitored continuously by the control unit 150 of the image capture and communication subsystem 130. If battery voltage and/or current drops below a determined threshold (e.g., 10.4 to 11 volts), below which continuous operation of the image capture and communication subsystem 130 cannot be reliably sustained, then the image capture and communication subsystem 130 generates a battery fault signal and wirelessly communicates the fault signal to the remote base station 160 for user attention. The battery fault signal alerts the user that maintenance is required, which may (for example) include repair, replacement or addition of a battery or a solar panel. If solar panel 105 output voltage and/or current deviates from a determined threshold during normal lighting conditions as determined by the photsensor 137, then the image capture and communication subsystem 130 generates a panel fault signal and wirelessly communicates the fault signal to the remote base station 160 for user attention. The panel fault signal alerts the user that maintenance is required, which may (for example) include repair, replacement or addition of a solar panel. By monitoring power supply subsystem 100 status, the system helps ensure continuous reliable operation of the image capture and communication subsystem 130. Optionally, the image capture and communication subsystem 130 may periodically communicate solar panel 105 battery 115 current and/or voltage output values to the remote base station 160 for performance tracking and charting.

A computer 170 operably coupled to a base unit 165 of the remote base station 160 correlates decoded aircraft identification information, e.g., tail numbers determined from the captured video by optical character recognition, to aircraft owner and/or operator records in a database to perform scheduling, reporting, security and billing functions. By way of example and not limitation, to automatically charge landing and parking fees, an airport fee schedule, which defines who and how much is to be invoiced, may be accessed to automatically calculate fees and produce and send invoices. The information may be communicated to one or more additional computers via LAN 175 and/or WAN 180 (e.g., the Internet).

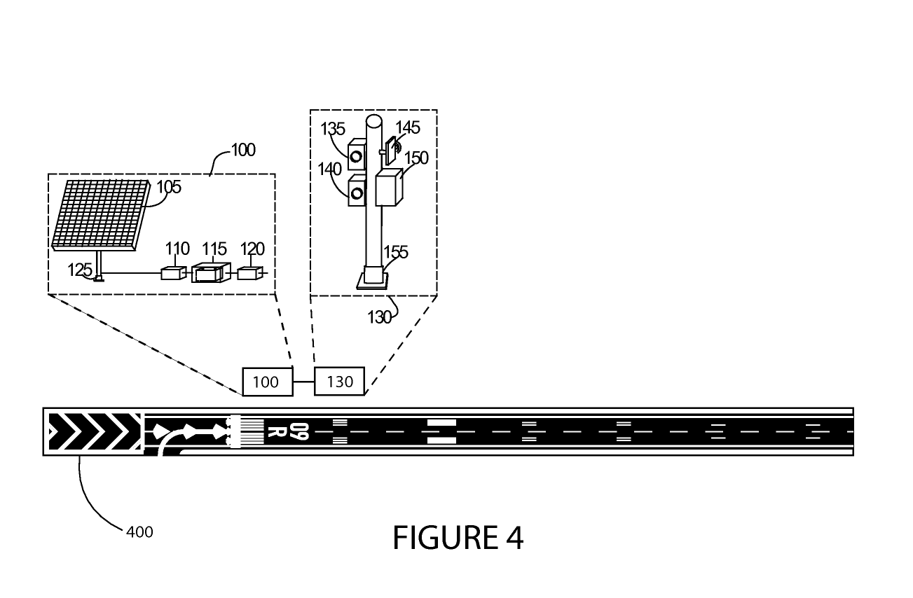

Referring now to FIG. 4, an example of a possible location for the image capture and communication subsystem 130 and power supply subsystem 100 in relation to a runway is conceptually shown. The image capture and communication subsystem 130 and power supply subsystem 100 are preferably located alongside the runway, at one or more locations, a safe distance from the runway. Preferably, the image capture and communication subsystem 130 is located with a field of view at landing and/or takeoff points so that all landings, take-offs, and touch-and-go's are detected and captured. The image capture and communication subsystem 130 and power supply subsystem 100 are located outside airport runway and taxiway obstacle free zones and safety areas, in compliance with all applicable rules, regulations and guidelines, including those pertaining to frangible mountings. The field of view of the camera 135 is set and focused to cover fuselage and tail sections sufficient to capture identification markings in high resolution from a safe distance. By way of example and not limitation, the field of view may vary depending upon the type and size of aircraft serviced by an airport, and may be from approximately 10 to 60 feet in height and width. The power supply subsystem 100 is preferably located adjacent to or in the vicinity of the image capture and communication subsystem 130, to reduce wiring requirements.

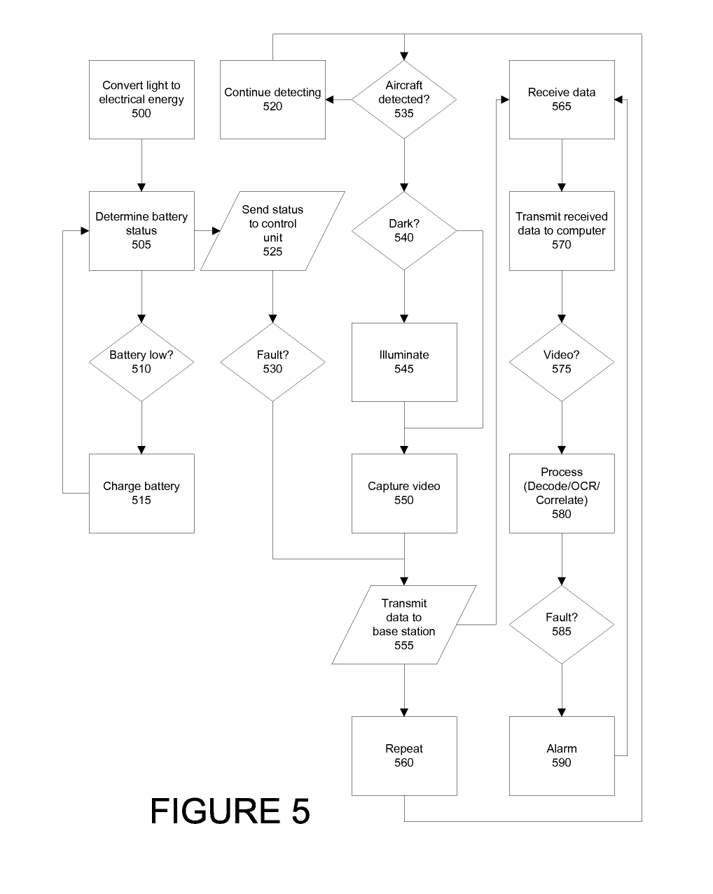

Referring now to FIG. 5, a flowchart of an exemplary method according to principles of the invention is conceptually shown. The method entails converting light energy to electrical energy as in step 500 using a solar panel 105. Then the charge status of the battery 115 is determined as in step 505, such as using a charge controller 110. If the battery is not fully charged, charging proceeds as in step 515 as long as there is sufficient ambient light to support charging.

Battery status is reported to the control unit 150 as in step 525. The control unit analyzes the status 525 to determine if there is a fault, as in step 530. In the event of a fault, a fault signal or code is wirelessly transmitted to the base station 160, as in step 555. Upon receiving the communicated signal/code, as in step 565, the base station 160 determines if it corresponds to a fault, as in step 585. If so, the base station generates an alarm, as in step 590.

The image capture and communication subsystem 130 continuously monitors the field of view for aircraft, as in steps 520 and 535. If an aircraft is detected, as in step 535, video is captured of the aircraft, particularly the identification information displayed on the aircraft, as in step 550. If there is insufficient natural ambient light for a good quality video, as determined in step 540, then the illuminator 140 is activated, as in step 545, while the video is captured. The video signals or data are then transmitted from the camera 135 to the control unit 150 and then wirelessly to the remote base station, as in step 555. The steps of detection, illumination in dark conditions, and video capture are repeated, as in step 560.

Upon receiving the communicated video signals/data, as in step 565, the base station 160 determines if it corresponds to video, as in step 575. If so, the base station processes the signal/data to determine the aircraft identification from the video and correlate the identification with records of a database, as in step 580. The steps of receiving communicated signals/data, and analyzing and processing them in response thereto, are repeated as additional data/signals are transmitted from the image capture and communication subsystem 130.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A battery-powered runway-based aircraft identification system comprising
a frangibly mounted image capture and communication subsystem adjacent to an airport runway; and
a power supply subsystem adjacent to said frangibly mounted image capture and communication subsystem and operably coupled to said frangibly mounted image capture and communication subsystem and configured to supply electrical power to said frangibly mounted image capture and communication subsystem, said power supply subsystem including at least one frangibly mounted solar panel operably coupled to a deep cycle battery, said frangibly mounted solar panel comprising photovoltaic cells configured to produce electrical energy from light energy; and
a remote base station configured for wireless communication with said frangibly mounted image capture and communication subsystem, said being located remote from said airport runway.

2. A battery-powered runway-based aircraft identification system according to claim 1, said frangibly mounted image capture and communication subsystem including a digital video camera configured with a field of view comprising a portion of the airport runway through which aircraft travel, said digital video camera being configured to capture digital video of aircraft on the runway.

3. A battery-powered runway-based aircraft identification system according to claim 1, said frangibly mounted image capture and communication subsystem including
a digital video camera configured with a field of view comprising a portion of the airport runway through which aircraft travel, said digital video camera being configured to capture digital video of aircraft on the runway; and
a sensor adapted to detect the presence of aircraft in the field of view.

4. A battery-powered runway-based aircraft identification system according to claim 1, said frangibly mounted image capture and communication subsystem including
a control unit; and
a digital video camera configured with a field of view comprising a portion of the airport runway through which aircraft travel, said digital video camera being configured to capture digital video of aircraft on the runway, said digital video camera being operably coupled to said control unit, and configured to communicate video image data to said control unit, and further configured to receive video control signals from said control unit; and
a sensor adapted to detect the presence of aircraft in the field of view, said sensor being operably coupled to said control unit, and configured to generate a detection signal and communicate the detection signal to said control unit; and
said control unit being configured to cause the digital video camera to capture video of the field of view when a detection signal has been received from the sensor by the control unit.

5. A battery-powered runway-based aircraft identification system according to claim 1, said frangibly mounted image capture and communication subsystem including
a control unit including a memory and transceiver; and
a digital video camera configured with a field of view comprising a portion of the airport runway through which aircraft travel, said digital video camera being configured to capture digital video of aircraft on the runway, said digital video camera being operably coupled to said control unit, and configured to communicate video image data to said control unit, and further configured to receive video control signals from said control unit; and
a sensor adapted to detect the presence of aircraft in the field of view, said sensor being operably coupled to said control unit, and configured to generate a detection signal and communicate the detection signal to said control unit; and
said control unit being configured to cause the digital video camera to capture video of the field of view when a detection signal has been received from the sensor by the control unit, and being configured to receive video image data from the digital video camera in memory of the control unit, and being further configured to wirelessly communicate said video image data to the remote base station.

6. A battery-powered runway-based aircraft identification system according to claim 1, said frangibly mounted image capture and communication subsystem including
a control unit including a memory and transceiver; and
a digital video camera configured with a field of view comprising a portion of the airport runway through which aircraft travel, said digital video camera being configured to capture digital video of aircraft on the runway, said digital video camera being operably coupled to said control unit, and configured to communicate video image data to said control unit, and further configured to receive video control signals from said control unit; and
a sensor adapted to detect the presence of aircraft in the field of view, said sensor being operably coupled to said control unit, and configured to generate a detection signal and communicate the detection signal to said control unit; and
said control unit being configured to cause the digital video camera to capture video of the field of view when a detection signal has been received from the sensor by the control unit, and being configured to receive video image data from the digital video camera in memory of the control unit, and being further configured to wirelessly communicate said video image data to the remote base station; and
said remote base station being configured to receive said video image data and determine an aircraft identification from said video image data by optical character recognition.

7. A battery-powered runway-based aircraft identification system according to claim 1, said power supply subsystem further including a charge controller operably coupled to said solar panel and to said deep cycle battery and configured to prevent overcharging of the deep cycle battery, overdischarging of the deep cycle battery, and reverse current drain from the deep cycle battery to the solar panel in dark conditions.

8. A battery-powered runway-based aircraft identification system according to claim 1, said power supply subsystem further including
a charge controller operably coupled to said frangibly mounted solar panel and said deep cycle battery and configured to prevent overcharging of the deep cycle battery, overdischarging of the deep cycle battery, and reverse current drain from the deep cycle battery to the frangibly mounted solar panel in dark conditions,
said charge controller including circuitry that determines the voltage of the deep cycle battery and regulates the current supplied from the frangibly mounted solar panel to the deep cycle battery using Pulse Width Modulation.

9. A battery-powered runway-based aircraft identification system according to claim 1, said power supply subsystem further including
a charge controller operably coupled to said frangibly mounted solar panel and said deep cycle battery and configured to prevent overcharging of the deep cycle battery, overdischarging of the deep cycle battery, and reverse current drain from the deep cycle battery to the frangibly mounted solar panel in dark conditions,
said charge controller including circuitry that determines the voltage of the deep cycle battery and regulates the current supplied from the frangibly mounted solar panel to the deep cycle battery using Maximum Power Point Tracking.

10. A battery-powered runway-based aircraft identification system according to claim 1, said power supply subsystem further including
a charge controller operably coupled to said frangibly mounted solar panel and said deep cycle battery and configured to prevent overcharging of the deep cycle battery, overdischarging of the deep cycle battery, and reverse current drain from the deep cycle battery to the frangibly mounted solar panel in dark conditions,
said charge controller including circuitry that determines the voltage of the deep cycle battery and regulates the current supplied from the frangibly mounted solar panel to the deep cycle battery using a process from the group consisting of Maximum Power Point Tracking and Pulse Width Modulation.

11. A battery-powered runway-based aircraft identification system according to claim 1, said deep cycle battery being an absorbed glass mat battery.

12. A battery-powered runway-based aircraft identification system according to claim 1, said power supply subsystem further including an inverter operably coupled to said deep cycle battery and configured to convert output of the deep cycle battery to alternating current.

13. A battery-powered runway-based aircraft identification system according to claim 1, said power supply subsystem further including an inverter operably coupled to said deep cycle battery and configured to convert output of the deep cycle battery to alternating current having a waveform from the group consisting of a sine wave, quasi-sine wave or modified sine wave.

14. A battery-powered runway-based aircraft identification system according to claim 1, said power supply subsystem further including a frangible mount supporting the frangibly mounted solar panel.

15. A battery-powered runway-based aircraft identification system according to claim 1, said power supply subsystem further including
a charge controller operably coupled to said frangibly mounted solar panel and said deep cycle battery and configured to prevent overcharging of the deep cycle battery, overdischarging of the deep cycle battery, and reverse current drain from the deep cycle battery to the frangibly mounted solar panel in dark conditions, and
said charge controller and battery being positioned beneath said frangibly mounted solar panel.

16. A battery-powered runway-based aircraft identification system according to claim 1, said power supply subsystem further including
a charge controller operably coupled to said frangibly mounted solar panel and said deep cycle battery and configured to prevent overcharging of the deep cycle battery, overdischarging of the deep cycle battery, and reverse current drain from the deep cycle battery to the frangibly mounted solar panel in dark conditions, and
said charge controller and battery being positioned beneath said frangibly mounted solar panel.

17. A battery-powered runway-based aircraft identification system according to claim 1, said power supply subsystem further including
a charge controller operably coupled to said frangibly mounted solar panel and said deep cycle battery and configured to determine an output voltage of the deep cycle battery and configured to prevent overcharging of the deep cycle battery, overdischarging of the deep cycle battery, and reverse current drain from the deep cycle battery to the frangibly mounted solar panel in dark conditions, and further configured to communicate the determined output voltage of the deep cycle battery to the frangibly mounted image capture and communication subsystem; and
said frangibly mounted image capture and communication subsystem adapted to determine if the determined output voltage of the deep cycle battery communicated from the charge controller is less than a determined voltage, and communicate a fault signal to the remote base station if the determined output voltage of the deep cycle battery communicated from the charge controller is less than a determined voltage.

18. A method for battery-powered runway-based aircraft identification comprising steps of
producing electrical energy from light energy using a solar panel,
determining a charge status of a battery using a charge controller, and if the battery is not fully charged, charging the battery using the electrical energy from the solar panel,
communicating the charge status to a control unit,
analyzing the charge status using the control unit to determine if there is a fault, and, in the event of a fault, producing a fault signal and wirelessly transmitting the fault signal to a remote base station,
receiving the fault signal at the base station and generating an alarm.

19. A method for battery-powered runway-based aircraft identification according to claim 18, further comprising steps of
monitoring a field of view of a runway for aircraft, and, if an aircraft is detected, capturing video of the aircraft including identification information displayed on the aircraft, and
if there is insufficient natural ambient light for a good quality video then activating an illuminator while the video is captured, and
transmitting the video from the camera to the control unit and then wirelessly to the remote base station.

20. A method for battery-powered runway-based aircraft identification according to claim 18, further comprising steps of
monitoring a field of view of a runway for aircraft, and, if an aircraft is detected, capturing video of the aircraft including identification information displayed on the aircraft, and
if there is insufficient natural ambient light for a good quality video then activating an illuminator while the video is captured, and
transmitting the video from the camera to the control unit and then wirelessly to the remote base station,
receiving the communicated video at the base station, and
determining an aircraft identification from the video, and
correlate the aircraft identification with a record of a database.
